(19) United States
(12) Patent Application Publication
(10) Pub. No.: US 2023/0142074 A1
(43) Pub. Date: May 11, 2023

(54) Rice Input Structure of Automatic Electric Pressure Cooker

(71) Applicant: Cuckoo Electronics Co., Ltd., Yangsan-si (KR)

(72) Inventors: Suk KIM, Yangsan-si (KR); Won Joo KIM, Yangsan-si (KR); You Jin SHIN, Yangsan-si (KR)

(73) Assignee: Cuckoo Electronics Co., Ltd., Yangsan-si (KR)

(21) Appl. No.: 18/051,642

(22) Filed: Nov. 1, 2022

(30) Foreign Application Priority Data
Nov. 5, 2021 (KR) 10-2021-0151736

(51) Int. Cl. A47J 27/086; B04C 5/04

(52) U.S. Cl. CPC A47J 27/086; B04C 5/04; A47J 27/0813

(57) ABSTRACT

A rice input structure of an automatic electric pressure cooker that automatically adds rice and water for cooking includes a cyclone rice separator mounted on a lid and having an opening/closing hole for putting rice into an inner pot, an air intake pipe connected to one side of the cyclone rice separator and generating a intake pressure, a rice transfer pipe connected in a tangential direction of the cyclone rice separator and connected to a rice container, a valve passing through an axial direction of the cyclone rice separator to open and close the opening/closing hole, and a valve opening/closing device having a link pressing an upper end of the valve and an actuator rotating the link.

### TECHNICAL FIELD

The present disclosure relates to a rice input structure of an automatic electric pressure cooker.

### BACKGROUND ART

In a related art electric rice cooker, the user puts as much rice and water as desired into an inner pot to cook, and the ratio of rice to water has to be constant to cook delicious rice. For users who are not skilled in adjusting the ratio of rice to water, an automatic rice cooker that may cook by automatically inputting a fixed amount of rice and water according to a specified capacity has been recently released.

However, when rice and water are intended to input into the inner pot, rice and water may be put into the inner pot with a lid of the rice cooker opened, or a separate rice inlet has to be provided to input rice and water with the lid closed.

The method of inputting rice and water by opening the lid of the rice cooker is disadvantageous in that a volume of the product itself increases, and therefore, the majority of automatic rice cookers currently on the market use a separate input port with the lid closed.

In the automatic rice cooker structure adopting a separate inlet, the inlet penetrates through all lid portions, and in order to prevent steam generated during cooking from penetrating into the lid through the inlet, the automatic rice cooker structure includes an opening and closing structure and a sealing structure of the inlet.

All of the currently released automatic rice cookers are non-pressure rice cookers that cook at the same pressure as atmospheric pressure, and the opening and closing and sealing structure of the inlet applied to the automatic rice cookers cannot withstand internal pressure applied during cooking when applied to a pressure cooker. Examples of prior art rice cookers are shown in China Registered Utility Model No. 205866584 and Japanese Patent Registration No. 3918630

### DISCLOSURE OF THE INVENTION

An aspect of the present disclosure is to provide a rice input structure of an automatic electric pressure cooker capable of effectively put rice, while withstanding internal pressure during cooking in a pressure cooker that automatically inputs rice and water.

In an aspect, a rice input structure of an automatic electric pressure cooker that automatically adds rice and water for cooking, includes: a cyclone rice separator mounted on a lid and having an opening/closing hole for putting rice into an inner pot; an air intake pipe connected to one side of the cyclone rice separator and generating a intake pressure; a rice transfer pipe connected in a tangential direction of the cyclone rice separator and connected to a rice container; a valve passing through an axial direction of the cyclone rice separator to open and close the opening/closing hole; and a valve opening/closing device having a link pressing an upper end of the valve and an actuator rotating the link.

In the rice input structure of the automatic electric pressure cooker according to the present disclosure, a valve opening and closing an opening/closing hole closes the opening/closing hole by the force of a valve spring, thereby withstanding internal pressure during cooking in a pressure cooker in which rice and water are automatically input.

In addition, in the rice input structure of the automatic electric pressure cooker according to the present disclosure, rice is put into the inner pot through a rice separator using a cyclone method and rice flour may be discharged together with the air, so that the taste of rice may be improved and a phenomenon in which rice flour is accumulated in the rice separator may be improved.

In addition, in the rice input structure of the automatic electric pressure cooker according to the present disclosure, a sealing surface of a valve may be cleaned by pulling a valve handle, thereby further improving sealing performance.

In the rice input structure of the automatic electric pressure cooker according to the present disclosure, a discharge flow forming space is formed in a ring shape (doughnut shape) around a concave portion to induce a flow of air introduced into the discharge flow forming space to be discharged, while producing whirlwind. By forming the ring-shaped discharge flow forming space and allowing a valve to pass through the center thereof, the valve may be opened and closed, while intaking rice and discharging a flow, without reducing a centrifugal rotational force of the flow.

### BRIEF DESCRIPTION OF THE DRAWINGS

FIG. 1 is a perspective view of an automatic electric pressure cooker having a rice input structure according to an embodiment of the present disclosure;

FIG. 2 is a cross-sectional view of an automatic electric pressure cooker having a rice input structure according to an embodiment of the present disclosure;

FIG. 3 is a perspective view illustrating a state in which a rice input structure of an automatic electric pressure cooker according to a first embodiment of the present disclosure is installed in a lid;

FIG. 4 is a cross-sectional view illustrating a state in which a rice input structure of an automatic electric pressure cooker according to the first embodiment of the present disclosure is installed in a lid;

FIG. 5 is a view illustrating a state in which a valve of a rice input structure of an automatic electric pressure cooker according to the first embodiment of the present disclosure is opened;

FIG. 6 is a plan view of a cyclone rice separator provided in an automatic electric pressure cooker according to the first embodiment of the present disclosure;

FIG. 7 is a cross-sectional view of a cyclone rice separator provided in an automatic electric pressure cooker according to the first embodiment of the present disclosure;

FIG. 8 is a top view of a third part of a cyclone rice separator provided in an automatic electric pressure cooker according to the first embodiment of the present disclosure;

FIG. 9 is a cross-sectional view taken along line G-G of FIG. 8;

FIG. 10 is a cross-sectional view taken along line B-B of FIG. 8;

FIG. 11 is a top view illustrating a second part of a cyclone rice separator provided in an automatic electric pressure cooker according to the first embodiment of the present disclosure;

FIG. 12 is a cross-sectional view taken along line F-F of FIG. 11;

FIG. 13 is a cross-sectional view taken along line S-S of FIG. 11;

FIG. 14 is a side view illustrating a second part of a cyclone rice separator provided in an automatic electric pressure cooker according to the first embodiment of the present disclosure;

FIG. 15 is a perspective view illustrating a first part of a cyclone rice separator provided in an automatic electric pressure cooker according to the first embodiment of the present disclosure;

FIG. 16 is a cross-sectional view of a cyclone rice separator provided in an automatic electric pressure cooker according to a second embodiment of the present disclosure;

FIG. 17 is a cross-sectional view of a cyclone rice separator provided in an automatic electric pressure cooker according to a third embodiment of the present disclosure; and

FIG. 18 is a cross-sectional view of a cyclone rice separator provided in an automatic electric pressure cooker according to a fourth embodiment of the present disclosure.

### DETAILED DESCRIPTION

Hereinafter, the present disclosure will be described in more detail with reference to the accompanying drawings.

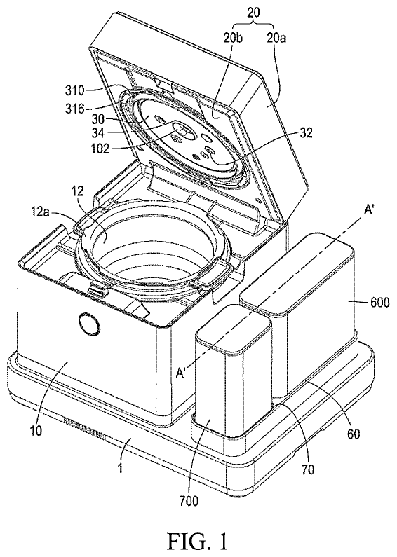

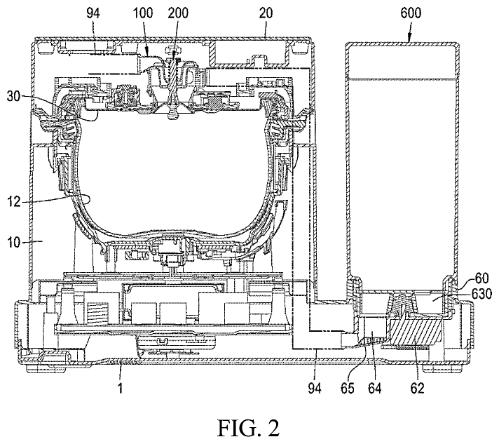

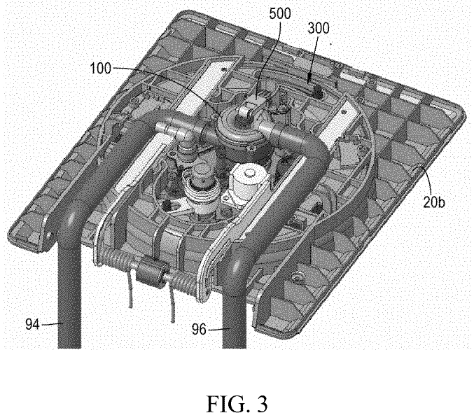

FIG. 1 is a perspective view of an automatic electric pressure cooker having a rice input structure according to an embodiment of the present disclosure, FIG. 2 is a cross-sectional view of an automatic electric pressure cooker having a rice input structure according to an embodiment of the present disclosure, and FIG. 3 is a perspective view illustrating a state in which a rice input structure of an automatic electric pressure cooker according to a first embodiment of the present disclosure is installed in a lid.

In the automatic electric pressure cooker having a rice input structure according to an embodiment of the present disclosure, a body 10 is coupled to a base 1, and the body 10 has a lid 20 for opening and closing the body 10. The lid 20 includes an inner lid 20b provided on an upper side of the body 10 to be opened and closed and an outer lid 20a covering an upper portion of the inner lid 20b. At this time, the outer lid 20a may form the exterior of the automatic electric pressure cooker and may protect various electrical components and wiring installed in the inner lid 20b. In addition, an inner pot lid 30 hermetically closing an upper portion of an inner pot is coupled to the inner lid 20b. In addition, the automatic electric pressure cooker includes a water container 700 storing water automatically input into the body 10 and a rice container 600 storing rice automatically input into the body 10. Here, the base 1 includes a water container coupling portion 70 controlling input of water and allowing the water container 700 to be coupled thereto and a rice container coupling portion 60 to which a measurer 630 included in the rice container 600 is coupled, on one side of the body 10.

A measurer 630 including a plurality of compartments is mounted in a lower portion of the rice container 600, and a motor 62 driving the measurer 630 is installed in the rice container coupling portion 60. By controlling rotation of the motor 62, discharge of rice through the measurer 630 may be controlled. When the measurer 630 is rotated by a predetermined angle by the motor 62, rice contained in the compartment of the measurer 630 falls to a rice intake portion 64 connected to a rice transfer pipe 94. In order to generate a forced flow, an inflow of outside air is required, and a plurality of through-holes 65 through which outside air is introduced are formed in the rice intake portion 64. At this time, a size of the through-hole 65 should be smaller than a size of the grain of rice. The outside air introduced through the through-hole 65 by a intake pressure of a intake fan (not shown) moves to a rice separator 100 along a rice transfer pipe 94 together with rice grains dropped to the rice intake portion 64.

Rice and water are put into the body 10 to substantially cook, and an inner pot 12 for storing rice at an appropriate temperature is installed, and a heating unit (not shown) such as a hot plate heater or an induction heating device is installed around the inner pot 12.

A locking ring 310 coupled to and locked with the inner pot 12 is provided on a lower surface of the inner lid 20b, and a water outlet 32 and a rice inlet 34 are installed in the inner pot lid 30. A cyclone rice separator 100 is installed on the rice inlet 34. In addition, the rice transfer pipe 94 is connected to the rice barrel coupling portion 60 in a tangential direction of the rice separator 100, an air intake pipe 96 is connected to one side of the cyclone rice separator 100 and connected to a intake fan (not shown) to generate a intake pressure. A valve 200 penetrates through the cyclone rice separator 100 in an axial direction to open and close an opening/closing hole 102 of the cyclone rice separator 100. A valve opening/closing device 500 is provided to press an upper end of the valve 200 to open and close the valve 200.

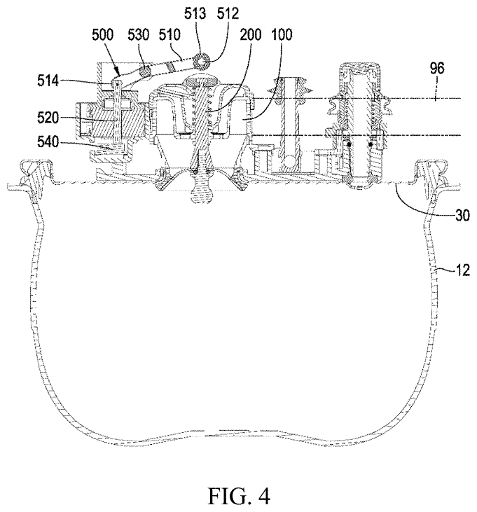

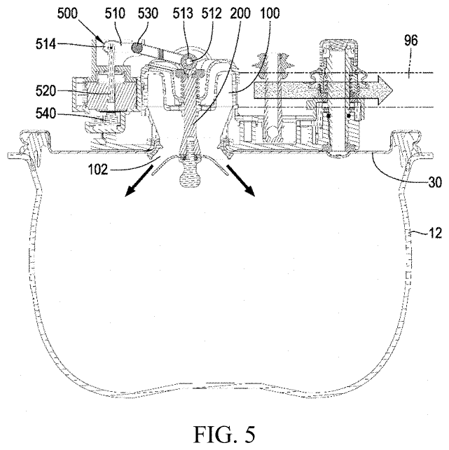

FIG. 4 is a cross-sectional view illustrating a state in which a rice input structure of an automatic electric pressure cooker according to the first embodiment of the present disclosure is installed in a lid, and FIG. 5 is a view illustrating a state in which a valve of a rice input structure of an automatic electric pressure cooker according to the first embodiment of the present disclosure is opened.

As described above, in the rice input structure of the automatic electric pressure cooker according to the first embodiment of the present disclosure, the opening/closing hole 102 of the cyclone rice separator 100 is opened and closed by the valve 200, and the valve opening/closing device 500 is provided to press the upper end of the valve 200 to open the valve 200.

The valve opening/closing device 500 includes a link 510 and an actuator 520 for rotating the link 510. The link 510 includes a pressing end 512 for pressing the valve 200 and a coupling end 514 connected to the actuator 520, and a rotating shaft 530 is connected to the middle of a body of the link 510 between the pressing end 512 and the coupling end 514. The rotating shaft 530 is connected to the middle of the body. Accordingly, when the actuator 520 moves up and down in a straight line, the link 510 rotates about the rotation shaft 530 and moves like a seesaw. Here, a roller 513 may be installed at the pressing end 512 for pressing the valve 200. When the pressing end 512 is lowered, the roller 513 rotates while pressing the valve 200, providing a more smooth operation.

An upper end of the actuator 520 is connected to the link 510, and a switch 540 is installed at a lower end of the actuator 520 to detect a vertical motion of the actuator 520. In a state in which the actuator 520 is lowered and the switch 540 is pressed, the valve 200 closes the opening/closing hole 102. When the actuator 520 rises and the contact with the switch 540 is released, the link 510 presses the valve 200 to open the opening/closing hole 102. In this manner, whether to open and close the valve 200 is detected to be used for control.

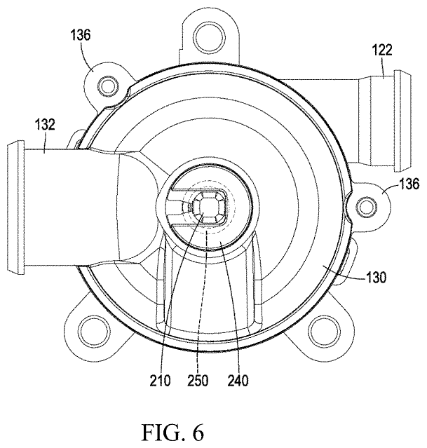

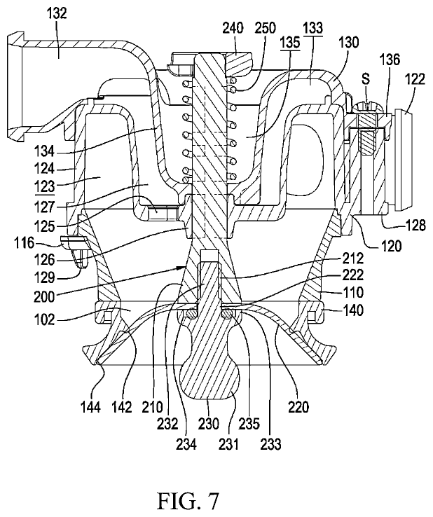

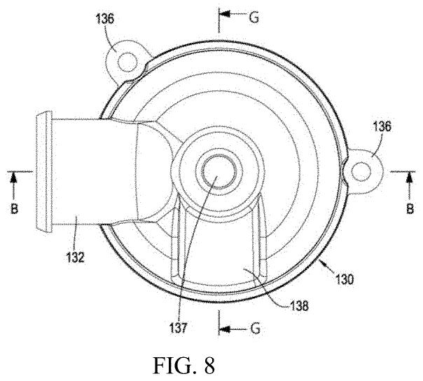

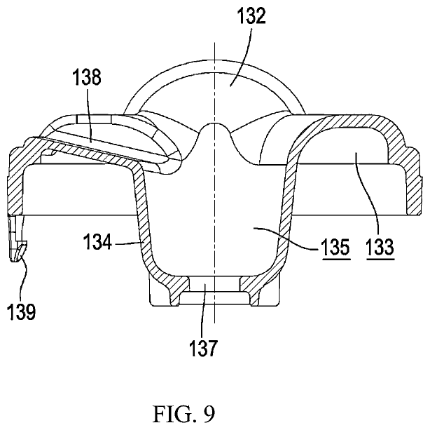

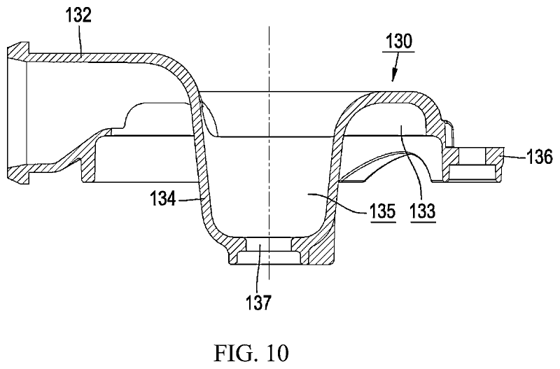

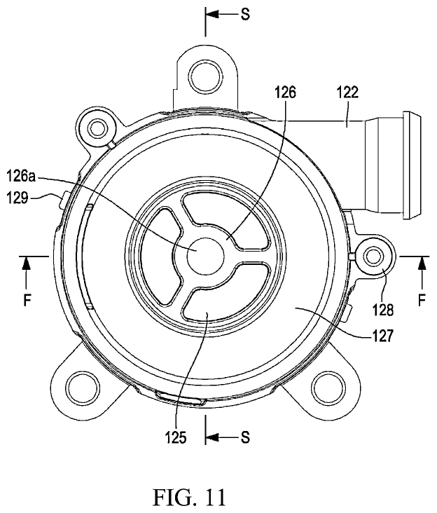

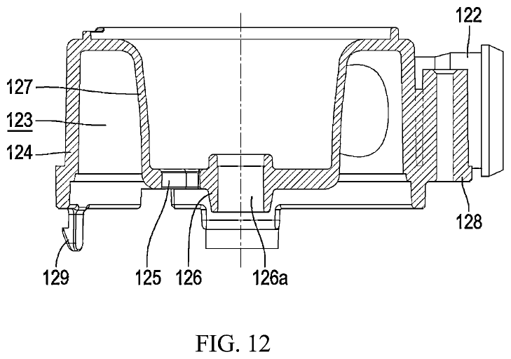

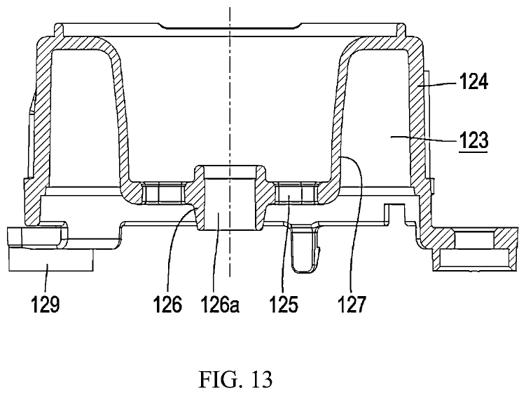

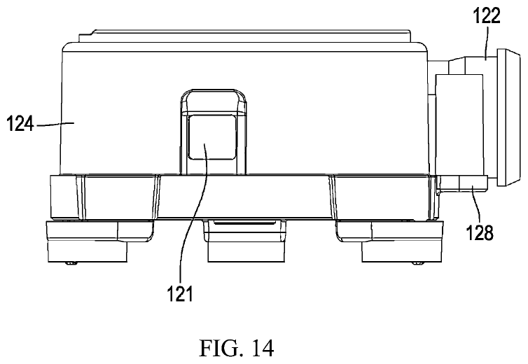

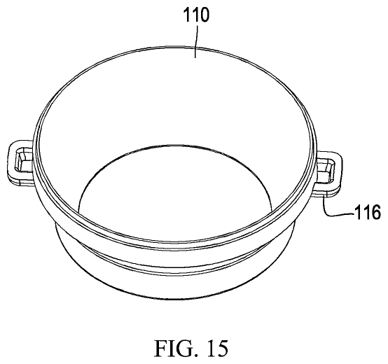

FIG. 6 is a plan view of a cyclone rice separator provided in an automatic electric pressure cooker according to the first embodiment of the present disclosure, FIG. 7 is a cross-sectional view of a cyclone rice separator provided in an automatic electric pressure cooker according to the first embodiment of the present disclosure, FIG. 8 is a top view of a third part of a cyclone rice separator provided in an automatic electric pressure cooker according to the first embodiment of the present disclosure, FIG. 9 is a cross-sectional view taken along line G-G of FIG. 8, FIG. 10 is a cross-sectional view taken along line B-B of FIG. 8, FIG. 11 is a top view illustrating a second part of a cyclone rice separator provided in an automatic electric pressure cooker according to the first embodiment of the present disclosure, FIG. 12 is a cross-sectional view taken along line F-F of FIG. 11, FIG. 13 is a cross-sectional view taken along line S-S of FIG. 11, FIG. 14 is a side view illustrating a second part of a cyclone rice separator provided in an automatic electric pressure cooker according to the first embodiment of the present disclosure, and FIG. 15 is a perspective view illustrating a first part of a cyclone rice separator provided in an automatic electric pressure cooker according to the first embodiment of the present disclosure.

The cyclone rice separator 100 provided in the automatic electric pressure cooker according to the first embodiment of the present disclosure includes a hopper-type first part 110, a second part 120 to which the rice transfer pipe 94 (refer to FIG. 3) is connected, a third part 130 to which the air intake pipe 96 (refer to FIG. 3) are connected, and a sealing material 140 attached to a lower end of the first part 110 and forming the opening/closing hole 102. The cyclone rice separator 100 has an overall circular cross-section to form a cyclonic flow.

The first part 110 is in the form of a hopper having a diameter narrowing downwardly, and the second part 120 is coupled to an upper end of the first part 110.

The second part 120 includes an input connector 122 for connecting the rice transfer pipe 94, and the input connector 122 is connected in a tangential direction of the second part 120 having a circular cross-sectional shape. Here, the tangential direction does not mean that the second part 120 and the input connector 122 are perfectly tangent but are connected to a position as close to the tangent as possible so that a flow introduced through the circular input connector 122 is attached to the inner surface of the second part 120 and flows.

The second part 120 includes a wall 124 protruding upwardly to form a ring shape to provide an introduced flow forming space 123 so that the flow introduced through the input connector 122 produces whirlwind. A circular concave portion 127 is formed in the center of the wall 124, and the wall 124 forms a discharge flow forming space 133 together with the third part 130. The discharge flow forming space 133 is formed in a ring shape (doughnut shape) around the concave portion 127 and induces air introduced therein to be discharged, while producing whirlwind. Since the ring-shaped discharge flow forming space 133 is formed and the valve 200 penetrates through the middle, rice may be intaken, without reducing a centrifugal rotational force of the flow, and the valve 200 may be opened and closed, while discharging the flow.

Meanwhile, a hole 126a through which a shaft portion 210 of the valve 200 to be described below passes is formed in the center of the concave portion 127. In addition, a valve guide portion 126 protruding up and down to guide the shaft portion 210 of the valve 200 to be described below is formed at the center of the concave portion 127. The hole 126a is formed at the center of the valve guide portion 126 so that the shaft portion 210 may pass therethrough. Meanwhile, a communication hole 125 through which air may flow from a space defined by the first part 110 and the second part 120 is formed near the valve guide portion 126 on a bottom surface of the concave portion 127.

The third part 130 may be coupled to an upper portion of the second part 120, and a wall 134 is formed to be spaced apart from an upper surface and an inner surface of the wall 124 of the second part by a predetermined interval to form the discharge flow forming space 133. A concave portion 135 is also formed in the center of the wall 134 of the third part 130, and the concave portion 135 of the third part 130 is concentric with the concave portion 127 of the second part and has a smaller diameter than that of the concave portion 127 of the second part 120. The flow introduced into the discharge flow forming space 133 is connected to the air intake pipe 96 (refer to FIG. 3) through a first discharge connector 132 formed in the third part 130.

Referring to FIGS. 8 to 10, the wall 134 of the third part 130 protrudes upwardly to have a convex shape, and an escape 138 is formed to be flat without protruding so that the link 510 of the valve opening/closing device 500 may move. In addition, a screw fastening portion 136 is formed on an outer periphery of the wall 134 of the third part 130 for coupling with the second part 120. In addition, the wall 134 of the third part 130 includes a coupling hook 139 extending downwardly to guide a coupling position before screwing with the second part 120 and maintain the position.

In addition, as described above, the third part has a concave portion 135 in the center of the wall 134 and a hole 137 through which the shaft portion 210 of the valve 200 passes is provided in the center of the concave portion 135.

Referring to FIGS. 11 to 14, the second part 120 includes a screw fastening portion 128 coupled to the screw fastening portion 136 of the third part 130. The screw fastening portion 136 of the third part 130 and the screw fastening portion 128 of the second part 120 are formed at an overlapping position and are fastened by a screw s. In addition, a coupling recess 121 into which the coupling hook 139 of the third part 130 is inserted and coupled is formed on an outer surface of the wall 124 to guide a coupling position before screwing with the third part 130 and to maintain the position.

In addition, the second part 120 includes a hook 129 extending downwardly for fastening with the first part 110. Referring to FIG. 15, the first part 110 includes a coupling hole 116 into which the hook 129 is inserted.

The valve 200 includes the shaft portion 210 penetrating through the cyclone rice separator 100, a stopper 220 coupled to a lower end of the shaft portion 210 to be in close contact with the sealing material 140 to stop the opening/closing hole 102, and a grippable handle 230 coupled to the shaft portion 210 through the stopper 220.

A cap 240 is coupled to an upper end of the shaft portion 210 protruding to the outside of the third part 130, and an elastic member 250 providing a force to move the valve 200 upwardly is fitted to an outer periphery of the shaft portion 210. The elastic member 250 is installed between the third part 130 and the cap 240. That is, a lower end of the elastic member 250 is supported by the concave portion 135 of the third part 130, and an upper end of the elastic member 250 is supported by a lower surface of the cap 240. When a force based on the actuator 520 is not transmitted through the link 510, the shaft portion 210 of the valve 200 moves upwardly by a restoring force of the elastic member 250 and the stopper 220 is in close contact with the sealing material 140 to close the opening/closing hole 102.

The stopper 220 may have a hat, i.e., a parabolic antenna shape so that rice may easily slide down into the inner pot when the valve 200 is opened. That is, the stopper 220 has a shape with a center protruding upwardly and an outer periphery inclined downwardly. The stopper 220 may be formed of a stainless steel material to reliably withstand pressure of the inner pot during pressure cooking.

The sealing material 140 may include two or more sealing ribs 142 and 144 protruding toward the stopper 220 in order to increase a sealing force with the stopper 220. In addition, the sealing material 140 has an inclined cylindrical shape that is narrow at an upper end and widens toward a lower end so as to be in close contact with the stopper 220. As described above, the center of the sealing material 140 is the opening/closing hole 102, and the opening/closing hole 102 formed by the sealing material 140 is opened and closed by the stopper 220.

The stopper 220 is fixed to the shaft portion 210 by the handle 230 as described above. A screw tab 212 is formed at a lower end of the shaft portion 210, and a screw portion 232 coupled to the screw tab 212 of the shaft portion 210 is also formed at an upper end of the handle 230, so that the handle 230 and the shaft portion 210 are screwed to each other. At this time, a through-hole 222 is formed in the center of the stopper 220, and the screw portion 232 of the upper end of the handle 230 is coupled to the screw tab of the shaft portion 210 through the through-hole 222 of the stopper 220 to fix the stopper 220.

Here, the handle 230 has a lower end portion 231 having a shape that is easy to grip by the user. The handle 230 has a contact surface 233 in contact with a lower surface of the stopper 220 around the through-hole 222 of the stopper 220. A ring-shaped groove 234 is formed on the contact surface 233, and an O-ring 235 is inserted into the groove 234, thereby blocking leakage of pressure to a gap between the shaft portion 210, the stopper 220, and the handle 230 during cooking.

Meanwhile, rice flour may be accumulated on inner surfaces of the sealing material 140 and the stopper 220. In this case, the handle 230 may be pulled to form a gap between the sealing material 140 and the stopper 220, and then the inner surfaces of the sealing material 140 and the stopper 220 may be cleaned. In addition, since the handle 230 and the shaft portion 210 are screwed together, the handle 230 and the shaft portion 210 may be easily separated and coupled, and thus, the handle 230 may be separated to clean the sealing material 140 and the stopper, and thereafter, the handle 230 and the shaft portion 210 may be coupled to each other again.

As described above, as the link 510 rotates by the movement of the actuator 520, the pressing end 512 of the link 510 presses the cap 240 of the valve 200, while the shaft portion 210 descends. Accordingly, the opening/closing hole 102 is opened as the stopper 220 fixed to the shaft portion 210 also descends. When the opening/closing hole 102 is opened, rice in the rice container 50 moving through the rice transfer pipe 94 is intaken into the cyclone rice separator together with air through the input connector 122 connected in the tangential direction of the cyclone rice separator 100, and descends, while rotating in a spiral form by centrifugal force, to be discharged to the inner pot 12 through a gap between the sealing material 140 and the stopper 220. Meanwhile, the intaken air moves to the discharge flow forming space 133 through the communication hole 125 together with fine rice flour, and then is discharged through the first discharge connector 132.

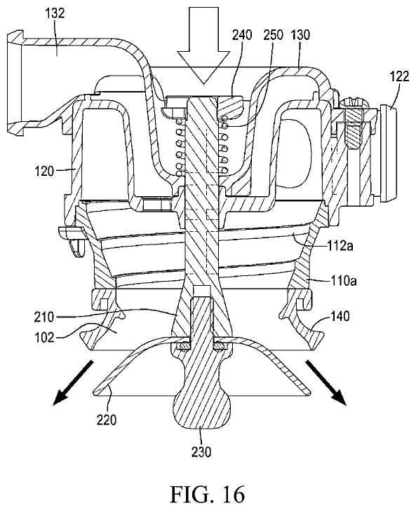

FIG. 16 is a cross-sectional view of a cyclone rice separator provided in an automatic electric pressure cooker according to a second embodiment of the present disclosure. The cyclone rice separator of an automatic electric pressure cooker according to the second embodiment of the present disclosure is the same as that of the first embodiment, except for a shape of a first part 110a. At this time, when a spiral groove 112a is formed on an inner surface of the first part 110a, rice may descend, while rotating in a rotational direction of the spiral groove 112a by centrifugal force when rice is intaken, so that rice may be more easily transported downwardly to be discharged.

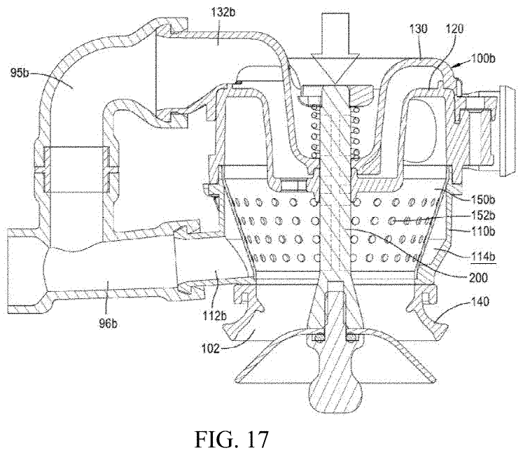

FIG. 17 is a cross-sectional view of a cyclone rice separator provided in an automatic electric pressure cooker according to a third embodiment of the present disclosure.

A cyclone rice separator of the automatic electric pressure cooker according to the third embodiment of the present disclosure is the same as that of the first embodiment, except for a shape of a first part 110b and the presence of an inner part 150b.

The inner part 150b is coupled to shake off rice flour in the first part 110b of the cyclone rice separator 100b. The inner part 150b and the first part 110b are not in close contact and are coupled with a gap 114b therebetween. The inner part 150b includes a plurality of through-holes 152b smaller than the size of a general rice grain, and when introduced rice descends, while rotating the inner part 150b spirally, flour on the surface of the rice falls due to frictional contact, and rice flour is discharged to the gap 114b through the through-hole 152b by strong centrifugal force.

In this case, the inner part 150b may additionally include a finely raised pattern to better shake off rice flour. For example, any pattern, such as a hairline pattern and a dot pattern, may be formed as needed.

Meanwhile, the first part 110b includes a second discharge connector 112b discharging a portion of rice flour and air. The second discharge connector 112b is connected to an air intake pipe 96b to intake a portion of rice flour and air by a intake pressure of the intake fan. Relatively large rice flour is discharged through the second discharge connector 112b, and light fine rice flour is discharged through the first discharge connector 132b formed in the third part 130. The air intake pipe 96b is branched into two portions at a predetermined position, and one portion thereof is connected to the first part 110b and the other portion is connected to the third part 130. In more detail, the first exhaust connector 132b is connected to the air intake pipe 96b connected to the intake fan through a connection pipe 95b, and the second discharge connector 112b is directly connected to the air intake pipe 96b. It may be more advantageous for the second discharge connector 112b to be located further on a lower side and directly connected to the air intake pipe 96b in terms of pipe assembly and arrangement, but the first discharge connector 132b may be connected to the air intake pipe 96b and the second discharge connector 112b may be connected to the air intake pipe 96b through the connection pipe 95b.

In addition, the sealing material 140 is attached to a lower portion of the first part 110b, and the opening/closing hole 102 formed in the sealing material 140 is opened and closed by the valve 200. The operation of the valve 200 is performed by the link 510 (refer to FIGS. 4 and 5) and the actuator 520 (refer to FIGS. 4 and 5) as in the first embodiment.

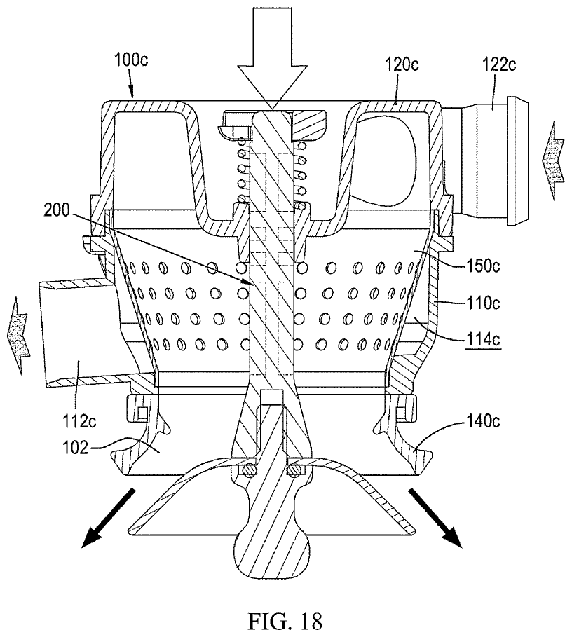

FIG. 18 is a cross-sectional view of a cyclone rice separator provided in an automatic electric pressure cooker according to a fourth embodiment of the present disclosure.

In a cyclone rice separator of an automatic electric pressure cooker according to the fourth embodiment of the present disclosure, the third part 130 (refer to FIG. 7) is omitted in the cyclone-type rice separator 100 of the first embodiment, and the configuration and connection of other parts relationship are changed. In a cyclone rice separator 100c according to the fourth embodiment of the present disclosure, a discharge connector 112c is formed in a hopper-type first part 110c and is connected to the air intake pipe 96 (refer to FIG. 3). An inner part 150c having a plurality of perforated holes is mounted inside the first part 110c with a gap 114c from the first part 110c. A second part 120c is coupled to upper portions of the first part 110c and the inner part 150c. An input connector 122c is formed in the second part 120c and is connected to the rice transfer pipe 94 (refer to FIG. 3).

In addition, a sealing material 140c is attached to a lower portion of the first part 110c, and the opening/closing hole 102 formed in the sealing material 140c is opened and closed by the valve 200. The operation of the valve 200 is performed by the link 510 (refer to FIGS. 4 and 5) and the actuator 520 (refer to FIGS. 4 and 5) as in the first and second embodiments.

While the present disclosure has been shown and described in connection with the embodiments, it will be apparent to those skilled in the art that modifications and variations may be made without departing from the spirit and scope of the invention as defined by the appended claims.

What is claimed is:

1. A rice input structure of an automatic electric pressure cooker that automatically adds rice and water for cooking, the rice input structure comprising:
a cyclone rice separator mounted on a lid and having an opening/closing hole for putting rice into an inner pot;
an air intake pipe connected to one side of the cyclone rice separator and generating a intake pressure;
a rice transfer pipe connected in a tangential direction of the cyclone rice separator and connected to a rice container;
a valve passing through an axial direction of the cyclone rice separator to open and close the opening/closing hole; and
a valve opening/closing device having a link pressing an upper end of the valve and an actuator rotating the link.

2. The rice input structure of claim 1, wherein the cyclone rice separator includes a hopper-type first part, a second part to which a rice transfer pipe is connected, a third part to which an air intake pipe is connected, and a sealing material attached to a lower end of the first part to form an opening/closing hole, and the second part includes a communication hole connecting the first part to the third part.

3. The rice input structure of claim 2, wherein the cyclone rice separator is defined by the second part and the third part, and has a ring-shaped discharge flow forming space connected to the air intake pipe and the communication hole.

4. The rice input structure of claim 2, wherein the first part includes a spiral groove.

5. The rice input structure of claim 2, wherein the first part is connected to the air intake pipe, and the cyclone rice separator further includes an inner part mounted inside the first part and having a plurality of perforated holes.

6. The rice input structure of claim 5, wherein the inner part has a raised pattern to shake off rice flour.

7. The rice input structure of claim 5, wherein the air intake pipe branches at a predetermined position to be connected to both the first part and the third part.

8. The rice input structure of claim 1, wherein the cyclone rice separator includes a hopper-type first part to which an air intake pipe is connected, a second part to which a rice transfer pipe is connected, an inner part mounted inside the first part and having a plurality of perforated holes, and a sealing material attached to a lower end of the first part and forming an opening/closing hole.

9. The rice input structure of claim 1, further comprising an elastic member having both ends supported by an upper surface of the cyclone rice separator and an upper end of the valve, and acting force in a direction in which the valve is closed.

10. The rice input structure of claim 1, wherein the valve includes a shaft portion penetrating through the cyclone rice separator, a stopper coupled to a lower end of the shaft portion to be in close contact with the cyclone rice separator to close the opening/closing hole, and a grippable handle coupled to the shaft portion through the stopper.

11. The rice input structure of claim 10, wherein the stopper has a parabolic antenna shape with a center protruding upwardly and an outer periphery inclined downwardly.

12. The rice input structure of claim 11, wherein the stopper is formed of stainless steel.

13. The rice input structure of claim 11, wherein the cyclone rice separator includes a cylindrical sealing material forming an opening/closing hole at a lowermost end thereof, and the sealing material has a diameter that is large at a lower end and narrowed upwardly to be in close contact with the stopper.

14. The rice input structure of claim 1, wherein the cyclone rice separator includes a cylindrical sealing material forming an opening/closing hole at a lowermost end thereof, and the sealing material includes two or more sealing ribs protruding toward the valve.
